(19) United States
(12) Patent Application Publication
(10) Pub. No.: US 2026/0136052 A1
(43) Pub. Date: May 14, 2026

(54) CONTENT RECOMMENDATION METHOD, ELECTRONIC DEVICE AND NON-TRANSITORY STORAGE MEDIUM

(71) Applicant: Beijing Zitiao Network Technology Co. Ltd., Beijing (CN)

(72) Inventors: Pengfei DOU, Beijing (CN); Jingxiang YUE, Beijing (CN); Wenlong CHEN, Beijing (CN); Kang AN, Beijing (CN)

(21) Appl. No.: 19/310,653

(22) Filed: Aug. 26, 2025

(30) Foreign Application Priority Data
Nov. 8, 2024 (CN) 202411595391.6

(51) Int. Cl. H04N 21/25; H04N 21/44; H04N 21/482

(52) U.S. Cl. CPC H04N 21/251; H04N 21/44008; H04N 21/4826

(57) ABSTRACT

The present disclosure provides a content recommendation method, an electronic device and a non-transitory storage medium. The content recommendation method includes: in response to an edit-triggering operation input in a first editing scenario of a client, obtaining first media content edited in the first editing scenario; in response to that the first media content includes second media content in a first preset format, determining a first content feature of the second media content, determining first transmission content according to the first content feature, and sending the first transmission content to a server; and receiving first recommended content corresponding to the first editing scenario and the first transmission content fed back by the server, and displaying the first recommended content in association with the first media content.

### CROSS-REFERENCE TO RELATED APPLICATION

This application claims the priority to and benefits of the Chinese Patent Application No. 202411595391.6, which was filed on Nov. 8, 2024. The aforementioned patent application is hereby incorporated by reference in its entirety.

### TECHNICAL FIELD

Embodiments of the present disclosure relate to the technical field of computer processing technology, and more particularly, to a content recommendation method, an electronic device and a non-transitory storage medium.

### BACKGROUND

In the field of information technology, an increasing number of users may perform content editing through relevant platforms and publish the edited content on the platforms. During the content editing process by a user, relevant editing reference content may be recommended to the user to meet user's content editing needs to the greatest extent.

In the related art, in relevant content recommendation methods, the recommended content is often dominated by the majority of accounts or the content with high popularity on the information interaction platform, that is, the editing reference content recommended to the user is determined based on the popularity or click-through rate of the content. Such a content recommendation method may result in a low content relatedness between the content edited by the user and the recommended editing reference content, rendering the recommended editing reference content ineffective as a reference for the user's content editing process, which in turn may negatively impact the user's content editing efficiency and content creation experience.

### SUMMARY

The present disclosure provides a content recommendation method, an electronic device and a non-transitory storage medium, so as to achieve the effect of determining relevant recommended content based on edited media content in an editing scenario, thereby improving content editing efficiency and enhancing content creation experience.

The embodiments of the present disclosure provide a content recommendation method including:
in response to an edit-triggering operation input in a target editing scenario (for example, a first editing scenario) of a client, obtaining first media content edited in the target editing scenario;
in response to that the first media content includes second media content in a first preset format, determining a target content feature (for example, a first content feature) of the second media content, determining target transmission content (for example, a first transmission content) according to the target content feature, and sending the target transmission content to a server; and
receiving target recommended content corresponding to the target editing scenario and the target transmission content and fed back by the server, and displaying the target recommended content in association with the first media content.

The embodiments of the present disclosure further provide a content recommendation apparatus including:
a content editing trigger module configured to, in response to an edit-triggering operation input in a target editing scenario of a client, obtaining first media content edited in the target editing scenario;
a target content transmission module (for example, a first content transmission module) configured to, in response to that the first media content includes second media content in a first preset format, determine a target content feature of the second media content, determine target transmission content according to the target content feature, and send the target transmission content to a server; and
a recommended content display module configured to, in response to that the first media content includes second media content in a first preset format, determine a target content feature of the second media content, determine target transmission content according to the target content feature, and send the target transmission content to a server.

The embodiments of the present disclosure further provide an electronic device including:
one or more processors; and
a storage for storing one or more programs,
in response to that the one or more programs are executed by the one or more processors, the one or more processors are caused to implement the content recommendation method according to any of the embodiments of the present disclosure.

The embodiments of the present disclosure further provide a non-transitory storage medium including computer-executable instructions, when executed by a computer processor, the computer-executable instructions are used for executing the content recommendation method according to any one of the embodiments of the present application.

The embodiments of the present disclosure further provide a computer program product including a computer program, when executed by a processor, the computer program implements the content recommendation method according to any one of the embodiments of the present application.

### BRIEF DESCRIPTION OF DRAWINGS

The above and other features, advantages, and aspects of each embodiment of the present disclosure may become more apparent by combining drawings and referring to the following specific implementation modes. In the drawings throughout, same or similar drawing reference signs represent same or similar elements. It should be understood that the drawings are schematic, and originals and elements may not necessarily be drawn to scale.

FIG. 1 is a schematic flow chart of a content recommendation method according to an embodiment of the present disclosure;

FIG. 2 is an interface schematic diagram of an editing interface of a target editing scenario according to an embodiment of the present disclosure;

FIG. 3 is a schematic flow chart of another content recommendation method according to an embodiment of the present disclosure;

FIG. 4 is a schematic flow chart of a content recommendation flow according to an embodiment of the present disclosure;

FIG. 5 is a schematic flow chart of another content recommendation method according to an embodiment of the present disclosure;

FIG. 6 is a schematic flow chart of another content recommendation method according to an embodiment of the present disclosure;

FIG. 7 is a schematic structural diagram of a content recommendation apparatus according to an embodiment of the present disclosure; and

FIG. 8 is a schematic structural diagram of an electronic device according to an embodiment of the present disclosure.

### DETAILED DESCRIPTION

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that modifications of “one” and “more” mentioned in the present disclosure are schematic rather than restrictive, and those skilled in the art should understand that unless otherwise explicitly stated in the context, it should be understood as “one or more”.

The names of messages or information exchanged between a plurality of apparatuses in the embodiments of the present disclosure are used for illustrative purposes only, and are not indicated to limit the scope of these messages or information.

It may be understood that before using the technical solutions disclosed in the embodiments of the present disclosure, the types, scope of use, and usage scenarios of personal information involved in the present disclosure and the like shall be informed to the user and the user's authorization shall be obtained in an appropriate manner in accordance with relevant laws and regulations.

For example, in response to receive an active request from a user, a prompt message is sent to the user to explicitly prompt the user that an operation requested by the user will need to obtain and use the user's personal information. In this way, the user can choose whether to provide personal information to a software or hardware such as an electronic device, an application, a server, or a storage medium that performs the operation of the technical solution of the present disclosure according to the prompt message.

As an optional but non-limiting implementation, in response to receiving an active request from a user, the prompt message may be sent to the user in the form of a pop-up window, and the prompt message may be presented in the pop-up window in the form of text. In addition, the pop-up window may also carry a selection control for the user to select “agree” or “disagree” to provide personal information to the electronic device.

It may be understood that the above process of notifying and obtaining user authorization is only schematic, and does not limit the implementation of the present disclosure. Other manners that meet relevant laws and regulations may also be applied to the implementation of the present disclosure.

It may also be understood that the data (including but not limited to the data itself, data acquisition, or use) involved in the technical solutions of the present disclosure shall comply with the requirements of the corresponding laws, regulations, and related provisions.

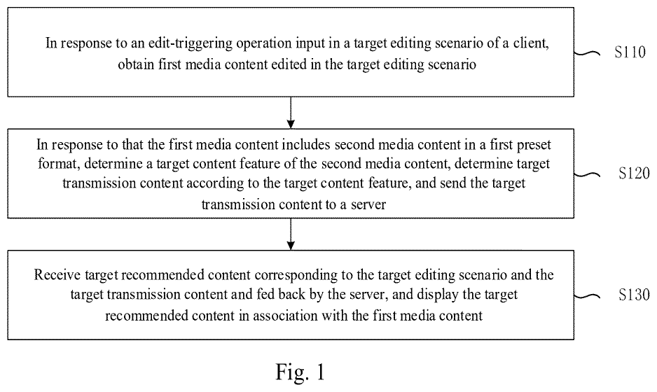

FIG. 1 is a schematic flow chart of a content recommendation method according to an embodiment of the present disclosure. The embodiment of the present disclosure is suitable for determining a scenario of a target recommended content recommended to a client for reference for content editing during a content editing process, and the method may be executed by a content recommendation apparatus, which may be implemented in the form of software and/or hardware, optionally by an electronic device, which may be a mobile terminal, a PC end or a server, and the like. As shown in FIG. 1, the method of the present embodiment may specifically include steps S110, S120 and S130.

At step S110, in response to an edit-triggering operation input in a target editing scenario of a client, obtain first media content edited in the target editing scenario.

The target editing scenario may be understood as a scenario provided to a user terminal to support the user to edit the content. The target editing scenario may include any scenario that supports editing by the user, optionally including a content posting scenario, an effect editing scenario, or a template editing scenario, and the like. The content posting scenario may be understood as a scenario where edited content is posted to an associated platform. The effect editing scenario may be understood as a scenario where effects are produced based on the edited content. The template editing scenario may be understood as a scenario where a template is produced based on the edited content. The edit-triggering operation may be understood as an operation that triggers editing of the associated media content. The edit-triggering operation may include a number of operations associated with content editing, optionally including image editing operations, text editing operations, audio-editing operations, video-editing operations, and the like. The image editing operation may include image shooting operations and/or image upload operations. The audio-editing operation may include an audio recording operation and/or an audio upload operation. The video-editing operation may include a video shooting operation and/or a video upload operation. The first media content may be understood as the media content obtained through editing based on the edit-triggering operation and to be transmitted to the server for processing. The first media content may include media content in at least one preset format. The preset formats may include text, images, audio and video, and the like. Illustratively, the first media content may include a landscape image and landscape description text associated with the landscape image.

In an embodiment of the present disclosure, an edit-triggering operation may be input in the target editing scenario of the client with respect to the target editing scenario of the client. Further, in response to that the edit-triggering operation input in the target editing scenario is received by the client, the content edited in the target editing scenario is determined according to the edit-triggering operation, the content is used as the first media content, and the first media content is used as a content basis for content processing based on the server.

As an alternative to the embodiment of the present disclosure, in response to that the target editing scenario is a content posting scenario, the edit-triggering operation may be input in the content posting scenario of the client to edit the content to be published. Further, in response to that the image editing operation and the text editing operation are received, the image edited in the content posting scenario may be determined in response to the image editing operation and the text editing operation, and the text edited in the content posting scenario may be determined according to the text editing operation. Further, the edited image and text may be obtained and the obtained image and text may be used as the first media content.

At step S120, in response to that the first media content includes second media content in a first preset format, determine a target content feature of the second media content, determine target transmission content according to the target content feature, and send the target transmission content to a server.

The first preset format may be a preset content format which needs to perform content feature extraction at the client. Alternatively, the first preset format may be a content format that affects content processing efficiency or enables intuitively representation of specific content. The first preset format may include any format capable of affecting content processing efficiency or enabling intuitively representation of specific content, optionally including at least one selected from a group consisting of an image format and a video format, and the like. The second media content may be media content that is included in the first media content and that has a content format that is a first preset format. Alternatively, in response to that images, text, and video are included in the first media content, the second media content may be the images and video included in the first media content. Illustratively, assuming that the first media content includes a landscape image and landscape description text associated with the landscape image, the second media content may be the landscape image. The target content feature may be understood as information that represents key attributes and features in media content. In an embodiment of the present disclosure, to improve content processing efficiency, feature extraction may be performed on the second media content to extract feature information in the second media content that represents key attributes and features of the content. Further, the extracted feature information may be regarded as a target content feature. The target content feature may be information represented in any form, and optionally, may be feature information based on vector representation. In other words, the target content feature may be a quantitative representation of the second media content, specifically a content feature vector. It should be noted that converting the second media content into the target content feature based on vector representation offers the advantages of improving content processing efficiency while avoiding potential content compliance risks, thereby enhancing the security of content transmission between the client and the server. The target transmission content may be understood as information which is finally sent to the server and is to be processed based on the server.

In practice, in response to that the edited first media content is obtained by the client, the obtained first media content is usually sent directly to the server. Further, the server processes the first media content so as to obtain the recommended content corresponding to the first media content. Then, the recommended content is fed back to the client. However, such a content processing method requires multiple transmissions of media content between a client and a server. In response to that the obtained first media content includes second media content (e.g. an image or a video) which affects content processing efficiency or may intuitively represents specific content, problems such as low content processing efficiency and compromised security of media content may arise.

In view of the above, in the embodiment of the present disclosure, in response to that the first media content edited in the target editing scenario is obtained, the content included in the first media content may be performed format detection. Further, in response to that the first media content includes the second media content in a first preset format, the second media content may be performed feature extraction so as to obtain target content features of the second media content. Further, the target transmission content which is finally sent to the server may be determined according to the target content feature. Further, the target transmission content may be sent to the server so as to process the target transmission content based on the server to obtain the content associated with the target transmission content.

It should be noted that there is at least one way to determine the target content feature of the second media content. Optionally, it includes performing feature extraction on the second media content based on a pretrained content extraction model; or processing the second media content according to a feature extraction algorithm, and so on.

It should also be noted that there are multiple was to determine the target transmission content according to the target content feature. Optionally, these ways include performing content replacement based on the target content feature; or performing content splicing based on target content feature, and the like.

As an alternative to the embodiment of the present disclosure, in response to that the first media content includes the second media content in a first preset format, the second media content may be input into a pretrained feature extraction model. Based on the feature extraction model, feature extraction is performed on the second media content and the target content feature is output. Further, the second media content in the first media content may be replaced with the target content feature, the replaced first media content may be used as the target transmission content, which is then sent to the server.

As another alternative to the embodiments of the present disclosure, in response to that the first media content includes the second content in the first preset format, the second media content may be input into a pretrained feature extraction model. Based on the feature extraction model, extract features is performed on the second media content, and the target content feature is output. Further, the first media content may be performed format detection. In response to that it is determined that the first media content includes third media content in other formats, the third media content and the target content feature may be used as the target transmission content. In response to that it is determined that the first media content does not include third media content in other formats, the target content features may be used as the target transmission content. Further, the target transmission content is sent to the server.

In the embodiment of the present disclosure, in response to that the first media content does not include the second media content in the first preset format, the first media content may be used as the target transmission content, and the target transmission content is sent to the server.

At step S130, receive target recommended content corresponding to the target editing scenario and the target transmission content and fed back by the server, and display the target recommended content in association with the first media content.

The target recommended content may be understood as display content that satisfies the interaction requirements of an input object of the edit-triggering operation. Alternatively, the target recommended content may also understood as display content that is finally recommended and displayed in the corresponding client. In an embodiment of the present disclosure, the target recommended content may be a candidate transmission content from the pre-stored candidate recommended content associated with the target editing scenario, where the content relevance between such candidate transmission content and the target transmission content meets the preset similarity threshold. Optionally, the target recommended content includes recommended editing content associated with the first media content. The recommended editing content may be understood as content recommended to a user for reference when the user re-edits the first media content. The recommended editing content may include a plurality of items of information for optimizing the first media content, optionally, include recommended editing text and/or an effect editing template. The recommended editing text may be understood as text recommended to the client as a reference for content editing. The recommended editing text may include a plurality of items of text for reference to the content edit, optionally, include a recommended content title for the first media content, recommended polished text, and recommended topics associated with the first media content. The recommended content title may be understood as text that is recommended to the client as a reference content title for the first media content. The recommended polished text may be understood as text obtained by being recommended to the client to polish or optimize the text edited in the first media content. Optionally, the recommended polished text may be text obtained by performing stylization processing on the text in the first media content based on a preset style type, or may be text obtained by processing the text in the first media content using a text generation model, and the like. The recommended topic may be understood as text obtained by being recommended to the client as an associated reference topic for the first media content. The effect editing template may be understood as a display effect template recommended to the client as a reference for content editing. The effect editing template may include a plurality of items of content associated with editing the media content, and optionally include an effect template image, an effect template text and an effect template effect, and the like.

In practice, in response to determine the target recommended content recommended to the client, a plurality of candidate recommended contents with a higher popularity and/or a higher click-through rate are usually determined from the prestored candidate recommended contents, and the determined plurality of candidate recommended contents are used as the target recommended content. However, such a recommended content determination method may result in a low content relatedness between the content edited by the user and the target recommended content. Consequently, the target recommended content fails to serve as a reference for the user's content editing process, which in turn impairs the user's content editing efficiency and content creation experience.

In view of the above, in the embodiment of the present disclosure, in response to that the server receives the target transmission content, content analysis may be performed based on the target transmission content determined by the server in the target editing scenario, so as to determine at least one candidate recommended content with a higher content relatedness to the target transmission content from the prestored candidate recommended content, and use the determined candidate recommended content as the target recommended content, and feedback the target recommended content to the client. Further, in response to that the client receives the target recommended content, a content editing operation may be input for the target recommended content by the client. Further, the target recommended content and the first media content may be displayed in an associated manner according to a content editing operation.

As an alternative to the embodiment of the present disclosure, in response to that the target transmission content is sent to the server, a plurality of candidate recommended content associated with the target editing scenario prestored in the server may be acquired. Further, the content relatedness between the target transmission content and each candidate recommended content may be respectively determined based on the server, so as to obtain a plurality of content relatedness. Further, a target content relatedness satisfying a preset similarity threshold may be determined from the plurality of content relatedness, and a candidate recommended content corresponding to the target content relatedness is used as a target recommended content corresponding to the target transmission content, and the target recommended content is fed back to the client based on the server. Further, in response to that the client receives the target recommended content fed back by the server, the target recommended content and the first media content may be displayed in an associated manner.

It should be noted that the number of target recommended contents fed back by the server may be one or more. In response to that the number of target recommended content is one, a content editing operation may be input to the first media content according to the target recommended content to display in association the target recommended content with the first media content. In response to that the number of the target recommended contents is plural, the target recommended contents may be displayed in an order from high to low depending on the content relatedness. Further, a content selection operation for the target recommended content may be received by the client, and the finally displayed target recommended content may be determined based on the content selection operation. Further, a content editing operation is input to the first media content according to the target recommended content to display in association the target recommended content with the first media content.

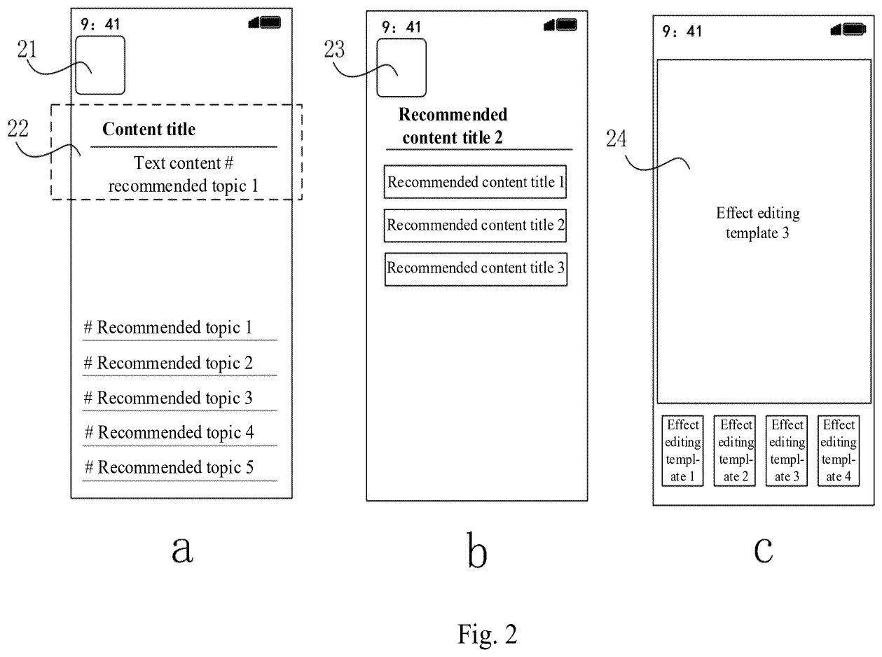

Illustratively, in order to facilitate a clearer description of the technical solutions according to an embodiment of the present disclosure, a target editing scenario is used as an example of an information post scenario. FIG. 2 is an interface schematic diagram of an editing interface of a target editing scenario according to an embodiment of the present disclosure. As shown in part a of FIG. 2, the edited first media content in the editing interface includes an edited image 21 and an edited text 22, and in the case of detecting an editing operation for a topic associated with the first media content, i.e., in the case of detecting that a user inputs “#” in the edited text, the edited image 21 may be performed feature extraction based on a client to obtain target content features, and the target content features and the edited text 22 are sent to a server as the target transmission content. Further, receiving 5 recommended topics corresponding to the target transmission content fed back by the server, which are sorted in descending order of content relatedness between the recommended topics and the target transmission content as follows: recommended topic 1, recommended topic 2, recommended topic 3, recommended topic 4, and recommended topic 5. Further, in a case when a user's selection trigger operation for recommended topic 1 is detected, the recommended topic 1 is added to the edited text to display in association the recommended topic 1 with the first media content. As shown in part b of FIG. 2, the editing interface includes an edited first media content including an edited image 23, and in response to that an editing operation for a content title for the first media content is detected, feature extraction may be performed on the edited image 23 based on a client to obtain target content features, and the target content features are sent to a server as the target transmission content. And then, in the case of receiving three recommended content titles corresponding to the target transmission content fed back by the server, which are sorted in descending order of content relatedness between the recommended topics and the target transmission content as follows: recommended content title 1, recommended content title 2 and recommended content title 3. Further, in response to that a user's selection trigger operation for recommended content title 2 is detected, the recommended content title 2 is added to the edited text to be displayed in association with the first media content. As shown in part c of FIG. 2, the edited first media content in the editing interface includes an edited image 24. In response to that an editing operation for the edited image is detected, feature extraction may be performed on the edited image 24 based on a client to obtain target content features, and the target content features are sent to a server as the target transmission content. Further, four effect editing templates corresponding to the target transmission content fed back by the server are received, which are sorted in descending order of content relatedness with the target transmission content as follows: the effect editing template 1, the effect editing template 2, the effect editing template 3 and the effect editing template 4. Further, in response to that a user's selection trigger operation for effect editing template 3 is detected, the template image in the effect editing template 3 is replaced with the edited image 24 to display in association the effect editing template 3 with the first media content.

According to the technical solution of the embodiments of the present disclosure, in response to an edit-triggering operation input in a target editing scenario of a client, first media content edited in the target editing scenario is obtained, which achieves the effect of obtaining the edited media content through a simple interactive operation, and provides a data basis for subsequently determining the recommended content. Further, in response to that the first media content includes second media content in a first preset format, a target content feature of the second media content is determined, target transmission content is determined according to the target content feature, and the target transmission content is sent to a server, which achieves the effect of performing feature extraction on the media content in a corresponding preset format based on the client, and determining the transmission content sent to the server based on the extracted feature, and by performing feature extraction on the client, the effect of ensuring content transmission security while improving content processing efficiency in the process of content transmission is achieved. Further, target recommended content corresponding to the target editing scenario and the target transmission content fed back by the server is received, and the target recommended content is displayed in association with the first media content, which solves the problem in the related art that the relatedness between the recommended content and the content edited by the user is relatively low, which in turn affects the user's content editing efficiency. It achieves the effect of determining the relevant recommended content according to the edited media content in the editing scenario, improving the content editing efficiency and improving the content creation experience. In addition, by performing feature extraction on the media content in the corresponding preset format through the client and determining the transmission content sent to the server based on the extracted features, it reduces the demand for network bandwidth and improves the efficiency of content transmission.

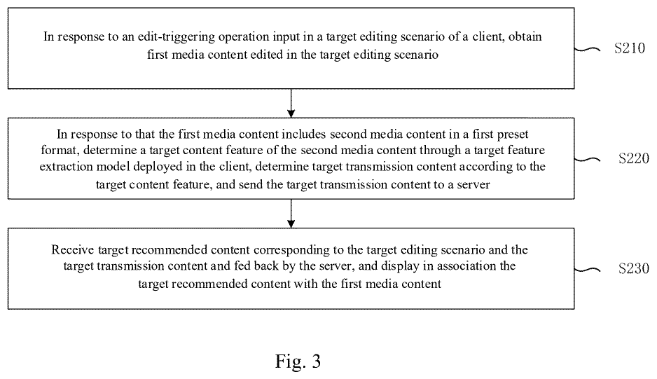

FIG. 3 is a schematic flow chart of another content recommendation method according to an embodiment of the present disclosure. The technical solution of the present embodiment further refines the determination method of the target content feature based on the above-mentioned embodiment. The determining the target content feature of the second media content includes: determining the target content feature of the second media content through a target feature extraction model deployed in the client. Specific implementation methods may refer to the descriptions of the present embodiment. The same or similar technical features as those of the previous embodiments will not be described in detail. As shown in FIG. 3, the method of the present embodiment may specifically include steps S210, S220 and S230.

At step S210, in response to an edit-triggering operation input in a target editing scenario of a client, obtain first media content edited in the target editing scenario.

At step S220, in response to that the first media content includes second media content in a first preset format, determine a target content feature of the second media content through a target feature extraction model deployed in the client, determine target transmission content according to the target content feature, and send the target transmission content to a server.

The target feature extraction model may be a neural network model which uses the media content as an input object to perform feature extraction on the media content. In the embodiment of the present disclosure, in order to reduce the demand for computing resource by the neural network model deployed in the client and to reduce the energy consumption for feature extraction performed by the client, the target feature extraction model may be a lightweight neural network model capable of performing feature extraction operations. Optionally, the target feature extraction model is determined according to the reference feature extraction model; the number of parameters of the reference feature extraction model is greater than that of the target feature extraction model. The number of parameters of the reference feature extraction model may reflect the model complexity of the reference feature extraction model. The number of parameters of the reference feature extraction model may be set to a larger value, that is to say, a more complex model may be selected. The specific value of the number of parameters of the reference feature extraction model may be set according to actual requirements, and is not particularly limited herein. For example, it may be several million megabytes. The number of parameters of the target feature extraction model may be a value smaller than that of the reference feature extraction model, and the specific value thereof may be a preset value or determined according to the deployed client, and is not particularly limited herein, and may be, for example, 3.9 M, 5 M or 10 M, and the like.

Optionally, the target feature extraction model is a target feature extraction model of the reference feature extraction model; and the target feature extraction model is obtained by performing knowledge distillation on the reference feature extraction model. The reference feature extraction model may be a deep neural network model deployed at the server for training the target feature extraction model. The reference feature extraction model may be a neural network model with a relatively complex model structure. It can be understood that the reference feature extraction model is a large and complex model that has undergone sufficient training and exhibits excellent performance. During the process of knowledge distillation, the reference feature extraction model may guide the training of the target feature extraction model, enabling the latter to achieve performance close to that of the reference feature extraction model. A target feature extraction model is a smaller and simpler model, usually with fewer parameters and a simpler model structure. Knowledge distillation is a technique for transferring knowledge learned by a large model with a relatively complex model structure (i.e., the reference feature extraction model) to a smaller model with a simpler model structure (i.e., the target feature extraction model), so as to achieve model compression and lightweight. Since the reference feature extraction model typically achieves higher accuracy but requires substantial resources and time for training, whereas the target feature extraction model trains faster with lower resource consumption, but generally exhibits inferior accuracy compared to the reference feature extraction model, the knowledge distillation enables the target feature extraction model to attain desired processing performance under limited resources by having the reference feature extraction model guide its training process. Optionally, the knowledge distillation may include various distillation approaches, including but not limited to response-based knowledge distillation, feature-based knowledge distillation, relation-based knowledge distillation, offline distillation, online distillation, and self-distillation.

In an embodiment of the present disclosure, before applying the target feature extraction model according to the embodiment of the present disclosure, the reference feature extraction model may be performed the knowledge distillation to obtain the target feature extraction model. Optionally, the process of performing knowledge distillation on the reference feature extraction model includes: constructing a training sample participating in the training reference feature extraction model, the training sample includes sample media content in a first preset format and an actual content feature corresponding to the sample media content; obtaining the reference feature extraction model based on training samples; constructing a target feature extraction model to be trained according to the reference feature extraction model; inputting sample media content in a training sample into the target feature extraction model to be trained to obtain a model prediction feature, and inputting sample media content in the training sample into the reference feature extraction model to obtain a model output feature; determining a first loss value according to the model prediction feature and the actual content feature in the sample media content, and determining a second loss value according to the model prediction feature and the model output feature; correcting the model parameters in the target feature extraction model to be trained according to the first loss value and the second loss value, and converging the loss function in the target feature extraction model to be trained as a training target so as to obtain the target feature extraction model.

As an alternative to the embodiment of the present disclosure, in response to that the target feature extraction model is trained, the target feature extraction model may be deployed at the client. Further, in response to that the first media content is obtained by the client and it is determined that the first media content includes the second media content in the first preset format, the second media content may be input into the target feature extraction model. Further, feature extraction may be performed on the second media content based on the target feature extraction model, and the target content feature may be output. Further, the target transmission content may be determined according to the target content feature, and the target transmission content may be sent to the server.

At step S230, receive target recommended content corresponding to the target editing scenario and the target transmission content and fed back by the server, and display in association the target recommended content with the first media content.

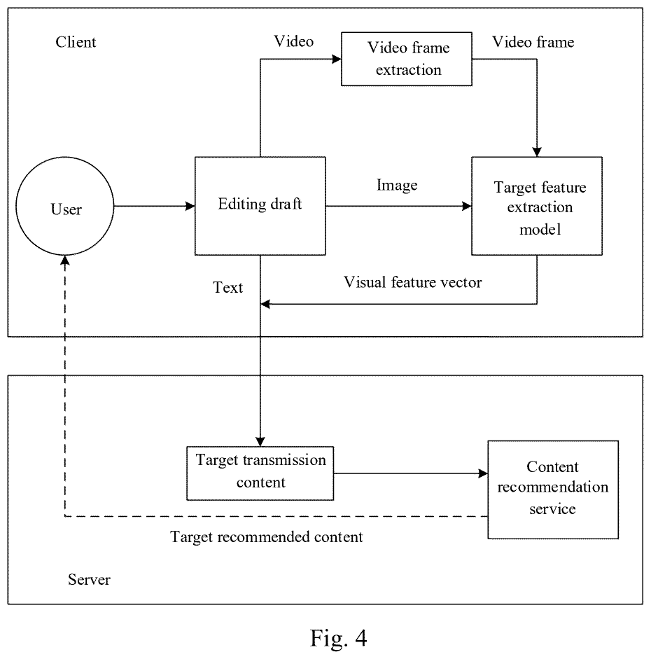

Illustratively, FIG. 4 is a schematic flow chart of a content recommendation flow according to an embodiment of the present disclosure. As shown in FIG. 4, a user inputs an edit-triggering operation via a client, and obtains an editing draft (i.e., a first media content) in a target editing scenario, where the editing draft includes a video, an image and text. Further, the video and images included in the edited draft may be used as the second media content, and the video may be performed frame extraction based on the client to obtain at least one video frame. Further, at least one video frame and an image in an editing draft are input to the target feature extraction model deployed in the client to obtain a visual feature vector (i.e., a target content feature) corresponding to the video and the image. Further, the visual feature vector and the text included in the editing draft may be used as the target transmission content, and the target transmission content may be sent to the server. Further, the target transmission content may be processed based on the content recommendation service deployed in the server so as to obtain the target recommended content. Further, the target recommended content may be fed back to the client so that the user edits the edited draft again based on the target recommended content.

In the technical solution of the embodiment of the present disclosure, in response to that the first media content includes second media content in a first preset format, by determining the target content feature of the second media content through a target feature extraction model deployed in the client, determining target transmission content according to the target content feature, and sending the target transmission content to a server, it achieves the effect of performing feature extraction on media content in the corresponding preset format based on the feature extraction model deployed in the client, reduces the demand for network bandwidth, lowers the energy consumption of the server, improves the efficiency of content transmission, and enhances the security and privacy of data transmission.

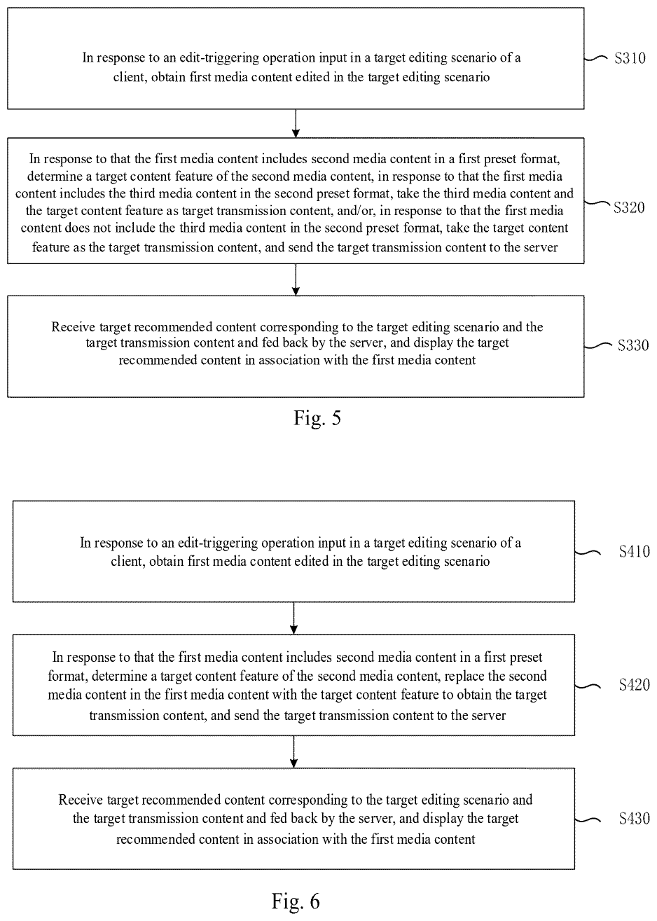

FIG. 5 is a schematic flow chart of another content recommendation method according to an embodiment of the present disclosure. The technical solution of the present embodiment further refines the determination method of the target transmission content based on the above-mentioned embodiment. The determining the target transmission content according to the target content feature includes: in response to that the first media content includes third media content in a second preset format, sending the third media content and the target content feature to the server; and/or, in response to that the first media content does not include the third media content in the second preset format, sending the target content feature to the server. Specific implementation methods may refer to the descriptions of the present embodiment. The same or similar technical features as those of the previous embodiments will not be described in detail. As shown in FIG. 5, the method of the present embodiment may specifically include steps S310, S320 and S330.

At step S310, in response to an edit-triggering operation input in a target editing scenario of a client, obtain first media content edited in the target editing scenario.

At step S320, in response to that the first media content includes second media content in a first preset format, determine a target content feature of the second media content, in response to that the first media content includes the third media content in the second preset format, take the third media content and the target content feature as target transmission content, and/or, in response to that the first media content does not include the third media content in the second preset format, take the target content feature as the target transmission content and send the target transmission content to the server.

The second preset format may be a preset content format which does not require content feature extraction at the client. Optionally, the first preset format includes at least an image format and/or a video format. The second preset format includes at least a text format. The third media content is the media content that is included in the first media content and whose content format is the second preset format.

As an alternative to the embodiments of the present disclosure, content format detection may again be performed on the first media content in response to that the target content feature of the second media content is determined. Further, in response to that it is determined that the first media content includes the third media content in the second preset format, the target content feature and the third media content may be taken as the target transmission content, and the target transmission content may be sent to the server, and/or, in response to that it is determined that the first media content does not include the third media content in the second preset format, the target content feature may be sent to the server as the target transmission content.

At step S330, receive target recommended content corresponding to the target editing scenario and the target transmission content and fed back by the server, and display the target recommended content in association with the first media content.

In the technical solution of the embodiments of the present disclosure, by taking the third media content and the target content feature as the target transmission content in response to that the first media content includes the third media content in the second preset format; and/or, by taking the target content feature as the target transmission content in response to that the first media content does not include the third media content in the second preset format, and sending the target transmission content to the server, it achieves the effect of determining the transmission content to be sent to the server based on the extracted content features in response to that the obtained media content includes content in different formats. It also achieves the effect of targeted processing of multimodal media content based on the client, enhancing the intelligence of content processing methods.

FIG. 6 is a schematic flow chart of another content recommendation method according to an embodiment of the present disclosure. The technical solution of the present embodiment further refines the determination method of the target transmission content based on the above-mentioned embodiment. The determining the target transmission content according to the target content feature includes: replacing the second media content in the first media content with the target content feature to obtain the target transmission content. Specific implementation methods may refer to the descriptions of the present embodiment. The same or similar technical features as those of the previous embodiments will not be described in detail. As shown in FIG. 6, the method of the present embodiment may specifically include steps S410, S420 and S430.

At step S410, in response to an edit-triggering operation input in a target editing scenario of a client, obtain first media content edited in the target editing scenario.

At step S420, in response to that the first media content includes second media content in a first preset format, determine a target content feature of the second media content, replace the second media content in the first media content with the target content feature to obtain the target transmission content, and send the target transmission content to the server.

In the embodiment of the present disclosure, in response to that the target content feature of the second media content is determined, the second media content in the first media content may be directly replaced with the target content feature to obtain the replaced first media content, and the replaced first media content may be taken as the target transmission content. Further, the target transmission content is sent to the server.

At step S430, receive target recommended content corresponding to the target editing scenario and the target transmission content and fed back by the server, and display the target recommended content in association with the first media content.

In the technical solution of the embodiments of the present disclosure, by replacing a second media content in a first media content with a target content feature to obtain a target transmission content, and sending the target transmission content to a server, the effect of directly performing content replacement based on the content feature in the case of obtaining a content feature corresponding to a media content of a preset format is achieved, the convenience of a content processing method is enhanced, the determination efficiency of the transmission content is improved, and further, the effect of improving the determination efficiency of the recommended content while ensuring the relatedness between the recommended content and the edited content is achieved.

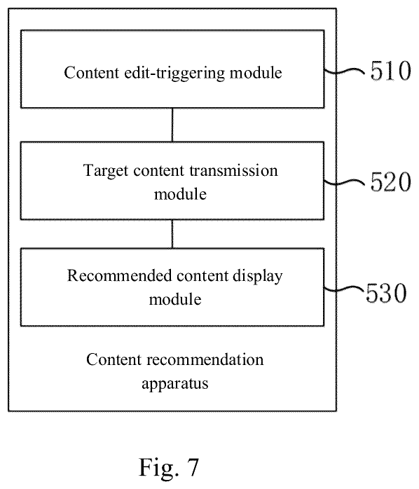

FIG. 7 is a schematic structural diagram of a content recommendation apparatus according to an embodiment of the present disclosure. As shown in FIG. 7, the apparatus includes: a content edit-triggering module 510, a target content transmission module 520, and a recommended content display module 530. The content edit-triggering module 510 is configured to, in response to an edit-triggering operation input in a target editing scenario of a client, obtaining first media content edited in the target editing scenario; the target content transmission module 520 is configured for, in response to that the first media content includes second media content in a first preset format, determining a target content feature of the second media content, determining target transmission content according to the target content feature, and sending the target transmission content to a server; and a recommended content display module 530 is configured for receiving target recommended content corresponding to the target editing scenario and the target transmission content and fed back by the server, and displaying the target recommended content in association with the first media content.

According to the technical solution of the embodiments of the present disclosure, in response to an edit-triggering operation input in a target editing scenario of a client, first media content edited in the target editing scenario is obtained, which achieves the effect of obtaining the edited media content through a simple interactive operation, and provides a data basis for subsequently determining the recommended content. Further, in response to that the first media content includes second media content in a first preset format, a target content feature of the second media content is determined, target transmission content is determined according to the target content feature, and the target transmission content is sent to a server, which achieves the effect of performing feature extraction on the media content in a corresponding preset format based on the client, and determining the transmission content sent to the server based on the extracted feature, and by performing feature extraction on the client, the effect of ensuring content transmission security while improving content processing efficiency in the process of content transmission is achieved. Further, target recommended content corresponding to the target editing scenario and the target transmission content fed back by the server is received, and the target recommended content is displayed in association with the first media content, which solves the problem in the related art that the relatedness between the recommended content and the content edited by the user is relatively low, which in turn affects the user's content editing efficiency. It achieves the effect of determining the relevant recommended content according to the edited media content in the editing scenario, improving the content editing efficiency and improving the content creation experience. In addition, by performing feature extraction on the media content in the corresponding preset format through the client and determining the transmission content sent to the server based on the extracted features, it reduces the demand for network bandwidth and improves the efficiency of content transmission.

Based on any optional technical solution in the embodiments of the present disclosure, optionally, the target content transmission module 520 is specifically configured to determine the target content feature of the second media content through a target feature extraction model deployed in the client. The target feature extraction model is determined according to a reference feature extraction model, and a number of parameters of the reference feature extraction model is greater than that of the target feature extraction model.

Based on any optional technical solution in the embodiments of the present disclosure, the target feature extraction model is obtained by performing knowledge distillation on the reference feature extraction model.

Based on any optional technical solution in the embodiments of the present disclosure, optionally, the target content transmission module 520 includes: a first content transmission unit and/or a second content transmission unit. The first content transmission unit is configured to, in response to that the first media content includes third media content in a second preset format, take the third media content and the target content feature as the target transmission content; and/or the second content transmission unit is configured to, in response to that the first media content does not include the third media content in the second preset format, take the target content feature as the target transmission content.

Based on any optional technical solution in the embodiments of the present disclosure, optionally, the first preset format includes at least one selected from a group consisting of an image format and a video format, and the second preset format includes at least a text format.

Based on any optional technical solution in the embodiments of the present disclosure, optionally, the target content transmission module 520 includes: a transmission content determination unit. The transmission content determination unit is configured to replace the second media content in the first media content with the target content feature to obtain the target transmission content.

Based on any optional technical solution in the embodiments of the present disclosure, optionally, the target recommended content includes recommended editing content associated with the first media content, and the recommended editing content includes at least one selected from a group consisting of recommended editing text and an effect editing template.

Based on any optional technical solution in the embodiments of the present disclosure, optionally, the recommended editing text includes a recommended content title for the first media content, recommended polished text, and recommended topics associated with the first media content.

The content recommendation apparatus according to the embodiments of the present disclosure may execute the content recommendation method according to any of the embodiments of the present disclosure, and has corresponding functional modules and advantageous effects for executing the content recommendation method.

It should be noted that various units and modules included in the above-mentioned apparatus are merely divided according to functional logic, but are not limited to the above-mentioned division, as long as corresponding functions may be achieved; in addition, the specific name of each functional units are only for convenience of distinguishing from each other, and are not intended to limit the scope of the embodiment of the present disclosure.

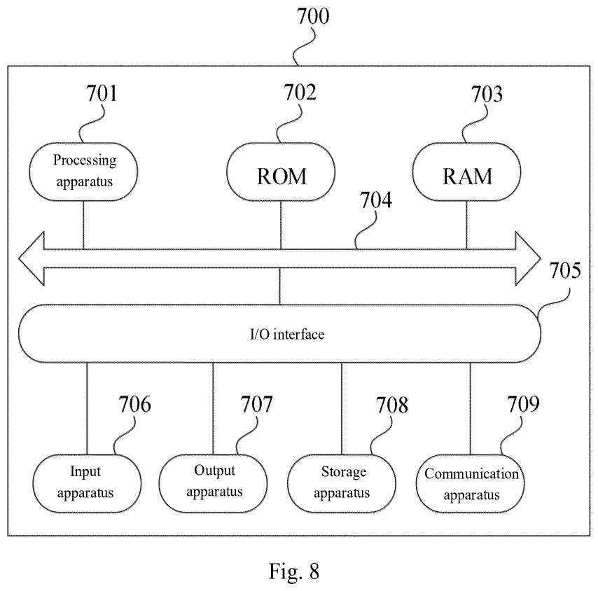

Referring to FIG. 8, FIG. 8 illustrates a schematic structural diagram of an electronic device (for example, a terminal device or a server in FIG. 8) 700 suitable for implementing some embodiments of the present disclosure. The electronic devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal) or the like, and fixed terminals such as a digital TV, a desktop computer, or the like. The electronic device illustrated in FIG. 8 is merely an example, and should not pose any limitation to the functions and the range of use of the embodiments of the present disclosure.

As illustrated in FIG. 8, the electronic device 700 may include a processing apparatus 701 (e.g., a central processing unit, a graphics processing unit, etc.), which can perform various suitable actions and processing according to a program stored in a read-only memory (ROM) 702 or a program loaded from a storage apparatus 708 into a random-access memory (RAM) 703. The RAM 703 further stores various programs and data required for operations of the electronic device 700. The processing apparatus 701, the ROM 702, and the RAM 703 are interconnected by means of a bus 704. An input/output (I/O) interface 705 is also connected to the bus 704.

Usually, the following apparatus may be connected to the I/O interface 705: an input apparatus 706 including, for example, a touch screen, a touch pad, a keyboard, a mouse, a camera, a microphone, an accelerometer, a gyroscope, or the like; an output apparatus 707 including, for example, a liquid crystal display (LCD), a loudspeaker, a vibrator, or the like; a storage apparatus 708 including, for example, a magnetic tape, a hard disk, or the like; and a communication apparatus 709. The communication apparatus 709 may allow the electronic device 700 to be in wireless or wired communication with other devices to exchange data. While FIG. 8 illustrates the electronic device 700 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 709 and installed, or may be installed from the storage apparatus 708, or may be installed from the ROM 702. When the computer program is executed by the processing apparatus 701, the above-mentioned functions defined in the methods of some embodiments of the present disclosure are performed.

The names of messages or information exchanged between multiple devices in the embodiments of the present disclosure are for illustrative purposes only and are not intended to limit the scope of such messages or information.

The electronic device according to the embodiments of the present disclosure and the content recommendation method according to the foregoing embodiments belong to the same inventive concept. For technical details not described in detail in the embodiments of the present disclosure, reference may be made to the foregoing embodiments, and this embodiment has the same beneficial effects as the foregoing embodiments.

The embodiments of the present disclosure provide a computer storage medium, on which a computer program is stored. When the program is executed by a processor, the content recommendation method according to the foregoing embodiments is implemented.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

According to one or more embodiments of the present disclosure, an example provides a content recommendation method, which including: in response to an edit-triggering operation input in a target editing scenario of a client, obtaining first media content edited in the target editing scenario; in response to that the first media content includes second media content in a first preset format, determining a target content feature of the second media content, determining target transmission content according to the target content feature, and sending the target transmission content to a server; and receiving target recommended content corresponding to the target editing scenario and the target transmission content and fed back by the server, and displaying the target recommended content in association with the first media content.

According to one or more embodiments of the present disclosure, the method further includes:
optionally, the determining a target content feature of the second media content, includes: determining the target content feature of the second media content through a target feature extraction model deployed in the client. The target feature extraction model is determined according to a reference feature extraction model, and a number of parameters of the reference feature extraction model is greater than that of the target feature extraction model.

According to one or more embodiments of the present disclosure, the method further includes:
optionally, the target feature extraction model is obtained by performing knowledge distillation on the reference feature extraction model.

According to one or more embodiments of the present disclosure, the method further includes:
optionally, the determining target transmission content according to the target content feature, includes: in response to that the first media content includes third media content in a second preset format, taking the third media content and the target content feature as the target transmission content; and/or, in response to that the first media content does not include the third media content in the second preset format, taking the target content feature as the target transmission content.

According to one or more embodiments of the present disclosure, the method further includes:
optionally, the first preset format includes at least one selected from a group consisting of an image format and a video format, and the second preset format include at least a text format.

According to one or more embodiments of the present disclosure, the method further includes:
optionally, the determining target transmission content according to the target content feature, includes:
replacing the second media content in the first media content with the target content feature to obtain the target transmission content.

According to one or more embodiments of the present disclosure, the method further includes:
optionally, the target recommended content includes recommended editing content associated with the first media content, and the recommended editing content include at least one selected from a group consisting of recommended editing text and an effect editing template.

According to one or more embodiments of the present disclosure, the method further includes:
optionally, the recommended editing text includes a recommended content title for the first media content, recommended polished text, and recommended topics associated with the first media content.

According to one or more embodiments of the present disclosure, an example provides a content recommendation apparatus including a content edit-triggering module configured to, in response to an edit-triggering operation input in a target editing scenario of a client, obtain first media content edited in the target editing scenario; a target content transmission module configured to, in response to that the first media content includes second media content in a first preset format, determine a target content feature of the second media content, determine target transmission content according to the target content feature, and send the target transmission content to a server; and a recommended content display module configured to receive target recommended content corresponding to the target editing scenario and the target transmission content and fed back by the server, and display the target recommended content in association with the first media content.

In some embodiments, clients, servers may communicate using any currently known or future developed network protocol, such as Hyper Text Transfer Protocol (HTTP), and may be interconnected with any form or medium of digital data communication (e.g., a communication network). Examples of communication networks include local area networks (“LAN”), wide area networks (“WAN”), internetworks (e.g., the Internet), and peer-to-peer networks (e.g., the ad hoc peer-to-peer network), as well as any network currently known or developed in the future.

The computer-readable medium may be included in the electronic device; it may also be present separately and not fitted into the electronic device.

The above-mentioned computer readable medium carries one or more programs, and when the above-mentioned one or more programs are executed by the electronic device, the electronic device is caused to: in response to an edit-triggering operation input in a target editing scenario of a client, acquire first media content edited in the target editing scenario; in response to that the first media content includes second media content in a first preset format, determine a target content feature of the second media content, determine target transmission content according to the target content feature, and send the target transmission content to a server; and receive target recommended content corresponding to the target editing scenario and the target transmission content fed back by the server, and present in association the target recommended content with the first media content.

Computer program code for carrying out operations of the present disclosure may be written in one or more programming languages, including but is not limited to object-oriented programming languages, such as Java, smalltalk, C++, and conventional procedural programming languages, such as the “C” language or similar programming languages, or combinations thereof. The program code may execute entirely on the user's computer, partly on the user's computer, as a stand-alone software package, partly on the user's computer, partly on a remote computer, or entirely on the remote computer or server. In the case of a remote computer, the remote computer may be connected to the user computer through any kind of network, including a local area network (LAN) or a wide area network (WAN), or may be connected to an external computer (e.g., through the Internet using an Internet service provider).

The flow charts and block diagrams in the figures illustrate the architecture, functionality, and operation of possible implementations of systems, methods, and computer program products according to various embodiments of the present disclosure. In this regard, each block in the flow chart or block diagrams may represent a module, segment, or portion of code, which includes one or more executable instructions for implementing the specified logical function(s). It should also be noted which, in some alternative implementations, the functions noted in the blocks may occur in a different order than that noted in the drawings. For example, two consecutive blocks may in fact be executed substantially in parallel, and they may sometimes be executed in the reverse order, depending on the functionality involved. Each block of the block diagrams and/or flow chart illustrations, and combinations of blocks in the block diagrams and/or flow chart illustrations, may be implemented by special purpose hardware-based systems which carry out the specified functions or acts, or combinations of special purpose hardware and computer instructions.

The elements described in connection with the embodiments disclosed herein may be implemented in software or hardware. The denomination of units shall not, under certain circumstances, be construed as limiting the units themselves. For example, the content edit-triggering module may alternatively be described as “a module configured to acquire first media content edited in the target editing scenario”.

The functions described herein above may be performed, at least in part, by one or more hardware logic components. For example, without limitation, exemplary types of hardware logic components that may be used include: Field Programmable Gate Arrays (FPGA), Specific Integrated Circuits (ASIC), Specific Standard Products (ASSP), System on a Chip (SOC), Complex Programmable Logic Devices (CPLD), and the like.

According to the present disclosure, a machine-readable medium may be a tangible medium that may contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination as above. More specific examples of a machine-readable storage medium may include one or more wire-based electrical connections, a portable computer diskette, a hard disk, a random-access memory (RAM), a read-only memory (ROM), an erasable programmable read-only memory (EPROM or Flash memory), an optical fiber, a portable compact disk read-only memory (CD-ROM), an optical storage, a magnetic storage, or any suitable combination thereof.

The foregoing description is only illustrative of the preferred embodiments of the present disclosure and of the principles of the technology employed. It will be appreciated by a person skilled in the art that the scope of disclosure covered by the present disclosure is not limited to any particular combination of the features set forth above, but is intended to cover any combination of the features set forth above or their equivalents without departing from the spirit of the present disclosure. For example, the above-mentioned features and the technical features disclosed in the present disclosure (but not limited to) having similar functions are replaced with each other to form a technical solution.

Further, while operations are depicted in a particular order, this should not be understood to require that the operations be performed in the particular order shown or in a sequential order. Under certain circumstances, multitasking and parallel processing may be advantageous. As such, specific implementation details have been included in the above discussion, these should not be construed as limiting the scope of the present disclosure. Certain features that are described in the context of separate embodiments may also be implemented in combination in a single embodiment. Conversely, various features that are described in the context of a single embodiment may also be implemented in a plurality of embodiments separately or in any suitable sub-combination.

Although the subject matter has been described in language specific to structural features and/or methodological acts, it is to be understood that the subject matter defined in the appended claims is not necessarily limited to the specific features or acts described above. Rather, the specific features and acts described above are merely example forms of implementing the claims.

1. A content recommendation method, comprising:
in response to an edit-triggering operation input in a first editing scenario of a client, obtaining first media content edited in the first editing scenario;
in response to that the first media content comprises second media content in a first preset format, determining a first content feature of the second media content, determining first transmission content according to the first content feature, and sending the first transmission content to a server; and
receiving first recommended content corresponding to the first editing scenario and the first transmission content and fed back by the server, and displaying the first recommended content in association with the first media content.

2. The content recommendation method according to claim 1, wherein the determining a first content feature of the second media content, comprises:
determining the first content feature of the second media content through a first feature extraction model deployed in the client, wherein the first feature extraction model is determined according to a reference feature extraction model, and a number of parameters of the reference feature extraction model is greater than a number of parameters of the first feature extraction model.

3. The content recommendation method according to claim 2, wherein the first feature extraction model is obtained by performing knowledge distillation on the reference feature extraction model.

4. The content recommendation method according to claim 1, wherein the determining first transmission content according to the first content feature, comprises:
in response to that the first media content comprises third media content in a second preset format, taking the third media content and the first content feature as the first transmission content.

5. The content recommendation method according to claim 4, wherein the first preset format comprises at least one selected from a group consisting of an image format and a video format, and the second preset format comprises at least a text format.

6. The content recommendation method according to claim 1, wherein the determining first transmission content according to the first content feature, comprises:
in response to that the first media content does not comprise the third media content in the second preset format, taking the first content feature as the first transmission content.

7. The content recommendation method according to claim 6, wherein the first preset format comprises at least one selected from a group consisting of an image format and a video format, and the second preset format comprises at least a text format.

8. The content recommendation method according to claim 1, wherein the determining first transmission content according to the first content feature, comprises:
in response to that the first media content comprises third media content in a second preset format, taking the third media content and the first content feature as the first transmission content; and
in response to that the first media content does not comprise the third media content in the second preset format, taking the first content feature as the first transmission content.

9. The content recommendation method according to claim 8, wherein the first preset format comprises at least one selected from a group consisting of an image format and a video format, and the second preset format comprises at least a text format.

10. The content recommendation method according to claim 1, wherein the determining first transmission content according to the first content feature, comprises:
replacing the second media content in the first media content with the first content feature to obtain the first transmission content.

11. The content recommendation method according to claim 1, wherein the first recommended content comprises recommended editing content associated with the first media content, and the recommended editing content comprises at least one selected from a group consisting of recommended editing text and an effect editing template.

12. The content recommendation method according to claim 7, wherein the recommended editing text comprises a recommended content title for the first media content, recommended polished text, and recommended topics associated with the first media content.

13. An electronic device, comprising:
one or more processors; and
a storage for storing one or more programs,
when the one or more programs are executed by the one or more processors, the one or more processors are caused to implement a content recommendation method,
wherein the content recommendation method comprises:
in response to an edit-triggering operation input in a first editing scenario of a client, obtaining first media content edited in the first editing scenario;
in response to that the first media content comprises second media content in a first preset format, determining a first content feature of the second media content, determining first transmission content according to the first content feature, and sending the first transmission content to a server; and
receiving first recommended content corresponding to the first editing scenario and the first transmission content fed back by the server, and displaying the first recommended content in association with the first media content.

14. The electronic device according to claim 13, wherein the determining a first content feature of the second media content, comprises:
determining the first content feature of the second media content through a first feature extraction model deployed in the client; wherein the first feature extraction model is determined according to a reference feature extraction model, and a number of parameters of the reference feature extraction model is greater than a number of parameters of the first feature extraction model.

15. The electronic device according to claim 14, wherein the first feature extraction model is obtained by performing knowledge distillation on the reference feature extraction model.

16. The electronic device according to claim 13, wherein the determining first transmission content according to the first content feature, comprises:
in response to that the first media content comprises third media content in a second preset format, taking the third media content and the first content feature as the first transmission content.

17. The electronic device according to claim 16, wherein the first preset format comprises at least one selected from a group consisting of an image format and a video format, and the second preset format comprises at least a text format.

18. The electronic device according to claim 13, wherein the determining first transmission content according to the first content feature, comprises:
in response to that the first media content comprises third media content in a second preset format, taking the third media content and the first content feature as the first transmission content; and
in response to that the first media content does not comprise the third media content in the second preset format, taking the first content feature as the first transmission content.

19. The electronic device according to claim 18, wherein the first preset format comprises at least one selected from a group consisting of an image format and a video format, and the second preset format comprises at least a text format.

20. A non-transitory storage medium comprising computer-executable instructions, wherein when executed by a computer processor, the computer-executable instructions are used for executing a content recommendation method,
wherein the content recommendation method comprises:
in response to an edit-triggering operation input in a first editing scenario of a client, obtaining first media content edited in the first editing scenario;
in response to that the first media content comprises second media content in a first preset format, determining a first content feature of the second media content, determining first transmission content according to the first content feature, and sending the first transmission content to a server; and
receiving first recommended content corresponding to the first editing scenario and the first transmission content fed back by the server, and displaying the first recommended content in association with the first media content.
